(19) United States
(12) Patent Application Publication
(10) Pub. No.: US 2015/0373101 A1
(43) Pub. Date: Dec. 24, 2015

(54) METHODS AND SYSTEMS FOR SYNCHRONIZING DATA BETWEEN TWO GEOGRAPHICALLY DISPARATE LOCATIONS

(71) Applicants: CLAUDE LANO COX, Austin, TX (US); LIAM B. QUINN, Austin, TX (US); MARK W. WELKER, Austin, TX (US); ROCCO ANCONA, Austin, TX (US)

(72) Inventors: CLAUDE LANO COX, Austin, TX (US); LIAM B. QUINN, Austin, TX (US); MARK W. WELKER, Austin, TX (US); ROCCO ANCONA, Austin, TX (US)

(21) Appl. No.: 14/308,459

(22) Filed: Jun. 18, 2014

(51) Int. Cl. H04L 29/08; G06F 1/16

(52) U.S. Cl. CPC H04L 67/1095; G06F 1/1632; H04L 67/1097

(57) ABSTRACT

Methods and systems for synchronizing data between two geographically disparate locations are disclosed. The method includes identifying a first file on a first device in communication with a first docking station; and obtaining a second file at a second docking station in communication with the first docking station. The method also includes calculating a difference between the first file and the second file and updating the first file using the difference.

### TECHNICAL FIELD

This disclosure relates generally to information handling systems and more particularly to methods and systems for synchronizing data between two geographically disparate locations.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In accordance with some embodiments of the present disclosure, a method for synchronizing data between two geographically disparate locations includes identifying a first file on a first device in communication with a first docking station; and obtaining a second file at a second docking station in communication with the first docking station. The method also includes calculating a difference between the first file and the second file and updating the first file using the difference.

In accordance with some embodiments of the present disclosure, a non-transitory computer readable medium includes computer readable instructions which, when executed, cause a processor to identify a first file on a first device in communication with a first docking station and obtain a second file at a second docking station in communication with the first docking station. The instructions, when executed, further cause the processor to calculate a difference between the first file and the second file and update the first file using the difference.

In accordance with some embodiments of the present disclosure, an information handling system includes a processor, a memory communicatively coupled to the processor, a docking station, and a synchronization module. The synchronization module includes computer readable instructions which, when executed, cause the processor to identify a first file on a first device in communication with a first docking station and obtain a second file at a second docking station in communication with the first docking station. The instructions, when executed, further cause the processor to calculate a difference between the first file and the second file and update the first file using the difference.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a block diagram of selected elements of an embodiment of an information handling system, in accordance with some embodiments of the present disclosure;

FIG. 2 illustrates an example network environment in which an information handling system may operate with other local or remote devices, in accordance with some embodiments of the present disclosure;

FIG. 3 illustrates a block diagram of selected elements of an embodiment of a docking station, in accordance with some embodiments of the present disclosure; and

FIG. 4 illustrates an example method for synchronizing data between two geographically disparate locations, in accordance with some embodiments of the present disclosure.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, entertainment, or other purposes. For example, an information handling system may be a personal computer (e.g., desktop or laptop), tablet computer, mobile device (e.g., personal digital assistant (PDA) or smart phone), server (e.g., blade server or rack server), a consumer electronic device, a network storage device, or another suitable device and may vary in size, shape, performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more storage devices, one or more communications ports (e.g., network ports) for communicating with external devices as well as various input and output (I/O) devices, such as a keyboard, a mouse, a touchscreen and/or a video display. The information handling system may also include one or more buses operable to transmit communication between the various hardware components.

For the purposes of this disclosure, a computer-readable non-transitory storage medium or media may include, without limitation, one or more semiconductor-based or other integrated circuits (ICs) (such as, for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

As will be described in further detail, the inventors of the present disclosure have discovered methods and systems for synchronizing data between two geographically disparate locations. The methods and systems detect differences between a copy of a file accessible to one docking station and a second copy of the file accessible to a second docking station. The docking stations use the detected differences to alter the older copy of the document to match the newer copy. In some embodiments, each file is located on a user device in communication with its respective docking station. In some embodiments, one file is located in a cloud storage system.

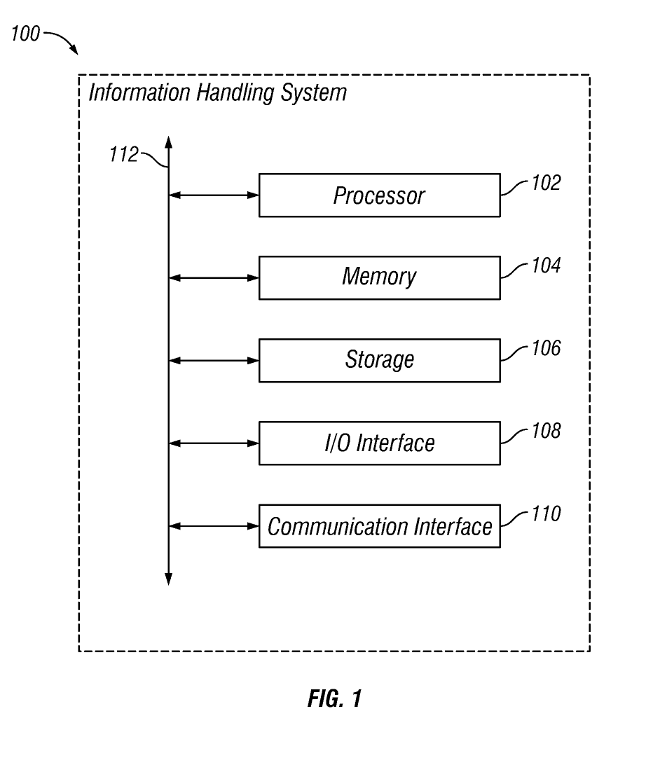

Particular embodiments are best understood by reference to FIGS. 1-4 wherein like numbers are used to indicate like and corresponding parts.

FIG. 1 is a block diagram of selected elements of an embodiment of information handling system 100, in accordance with some embodiments of the present disclosure. In particular embodiments, one or more information handling systems 100 perform one or more steps of one or more methods described or illustrated herein. In particular embodiments, one or more information handling systems 100 provide the functionality described or illustrated herein. In particular embodiments, software running on one or more information handling systems 100 performs one or more steps of one or more methods described or illustrated herein or provides functionality described or illustrated herein. Particular embodiments include one or more portions of one or more information handling systems 100. Herein, reference to an information handling system may encompass a computing device, and vice versa, where appropriate. Moreover, reference to an information handling system may encompass one or more information handling systems, where appropriate.

This disclosure contemplates any suitable number of information handling systems 100. This disclosure contemplates information handling system 100 taking any suitable physical form. As an example and not by way of limitation, information handling system 100 may be an embedded information handling system, a system-on-chip (SOC), a single-board information handling system (SBC) (such as, for example, a computer-on-module (COM) or system-on-module (SOM)), a desktop information handling system, a laptop or notebook information handling system, an interactive kiosk, a mainframe, a mesh of information handling systems, a mobile telephone, a personal digital assistant (PDA), a server, a tablet information handling system, or a combination of two or more of these. Where appropriate, information handling system 100 may include one or more information handling systems 100, be unitary or distributed, span multiple locations, span multiple machines, span multiple data centers, or reside in a cloud, which may include one or more cloud components in one or more networks. Where appropriate, one or more information handling systems 100 may perform without substantial spatial or temporal limitation one or more steps of one or more methods described or illustrated herein. As an example and not by way of limitation, one or more information handling systems 100 may perform in real time or in batch mode one or more steps of one or more methods described or illustrated herein. One or more information handling systems 100 may perform at different times or at different locations one or more steps of one or more methods described or illustrated herein, where appropriate.

In particular embodiments, information handling system 100 includes processor 102, memory 104, storage 106, input/output (I/O) interface 108, communication interface 110, and bus 112. Although this disclosure describes and illustrates a particular information handling system having a particular number of particular components in a particular arrangement, this disclosure contemplates any suitable information handling system having any suitable number of any suitable components in any suitable arrangement.

In particular embodiments, processor 102 includes hardware for executing instructions, such as those making up a computer program. As an example and not by way of limitation, to execute instructions, processor 102 may retrieve (or fetch) the instructions from an internal register, an internal cache, memory 104, or storage 106; decode and execute them; and then write one or more results to an internal register, an internal cache, memory 104, or storage 106. In particular embodiments, processor 102 may include one or more internal caches for data, instructions, or addresses. This disclosure contemplates processor 102 including any suitable number of any suitable internal caches, where appropriate. As an example and not by way of limitation, processor 102 may include one or more instruction caches, one or more data caches, and one or more translation lookaside buffers (TLBs). Instructions in the instruction caches may be copies of instructions in memory 104 or storage 106, and the instruction caches may speed up retrieval of those instructions by processor 102. Data in the data caches may be copies of data in memory 104 or storage 106 for instructions executing at processor 102 to operate on; the results of previous instructions executed at processor 102 for access by subsequent instructions executing at processor 102 or for writing to memory 104 or storage 106; or other suitable data. The data caches may speed up read or write operations by processor 102. The TLBs may speed up virtual-address translation for processor 102. In particular embodiments, processor 102 may include one or more internal registers for data, instructions, or addresses. This disclosure contemplates processor 102 including any suitable number of any suitable internal registers, where appropriate. Where appropriate, processor 102 may include one or more arithmetic logic units (ALUs); be a multi-core processor; or include one or more processors 102. Although this disclosure describes and illustrates a particular processor, this disclosure contemplates any suitable processor.

In particular embodiments, memory 104 includes main memory for storing instructions for processor 102 to execute or data for processor 102 to operate on. As an example and not by way of limitation, information handling system 100 may load instructions from storage 106 or another source (such as, for example, another information handling system 100) to memory 104. Processor 102 may then load the instructions from memory 104 to an internal register or internal cache. To execute the instructions, processor 102 may retrieve the instructions from the internal register or internal cache and decode them. During or after execution of the instructions, processor 102 may write one or more results (which may be intermediate or final results) to the internal register or internal cache. Processor 102 may then write one or more of those results to memory 104. In particular embodiments, processor 102 executes only instructions in one or more internal registers or internal caches or in memory 104 (as opposed to storage 106 or elsewhere) and operates only on data in one or more internal registers or internal caches or in memory 104 (as opposed to storage 106 or elsewhere). One or more memory buses (which may each include an address bus and a data bus) may couple processor 102 to memory 104. Bus 112 may include one or more memory buses, as described below. In particular embodiments, one or more memory management units (MMUs) reside between processor 102 and memory 104 and facilitate access to memory 104 requested by processor 102. In particular embodiments, memory 104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 104 may include one or more memories 104, where appropriate. Although this disclosure describes and illustrates particular memory, this disclosure contemplates any suitable memory.

In particular embodiments, storage 106 includes mass storage for data or instructions. As an example and not by way of limitation, storage 106 may include a hard disk drive (HDD), a floppy disk drive, flash memory, an optical disc, a magneto-optical disc, magnetic tape, or a Universal Serial Bus (USB) drive or a combination of two or more of these. Storage 106 may include removable or non-removable (or fixed) media, where appropriate. Storage 106 may be internal or external to information handling system 100, where appropriate. In particular embodiments, storage 106 is non-volatile, solid-state memory. In particular embodiments, storage 106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 106 taking any suitable physical form. Storage 106 may include one or more storage control units facilitating communication between processor 102 and storage 106, where appropriate. Where appropriate, storage 106 may include one or more storages 106. Although this disclosure describes and illustrates particular storage, this disclosure contemplates any suitable storage.

In particular embodiments, I/O interface 108 includes hardware, software, or both, providing one or more interfaces for communication between information handling system 100 and one or more I/O devices. Information handling system 100 may include one or more of these I/O devices, where appropriate. One or more of these I/O devices may enable communication between a person and information handling system 100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 108 for them. Where appropriate, I/O interface 108 may include one or more device or software drivers enabling processor 102 to drive one or more of these I/O devices. I/O interface 108 may include one or more I/O interfaces 108, where appropriate. Although this disclosure describes and illustrates a particular I/O interface, this disclosure contemplates any suitable I/O interface.

In particular embodiments, communication interface 110 includes hardware, software, or both providing one or more interfaces for communication (such as, for example, packet-based communication) between information handling system 100 and one or more other information handling systems 100 or one or more networks. As an example and not by way of limitation, communication interface 110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 110 for it. As an example and not by way of limitation, information handling system 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, information handling system 100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Information handling system 100 may include any suitable communication interface 110 for any of these networks, where appropriate. Communication interface 110 may include one or more communication interfaces 110, where appropriate. Although this disclosure describes and illustrates a particular communication interface, this disclosure contemplates any suitable communication interface.

In particular embodiments, bus 112 includes hardware, software, or both coupling components of information handling system 100 to each other. As an example and not by way of limitation, bus 112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 112 may include one or more buses 112, where appropriate. Although this disclosure describes and illustrates a particular bus, this disclosure contemplates any suitable bus or input/output (I/O) interconnect.

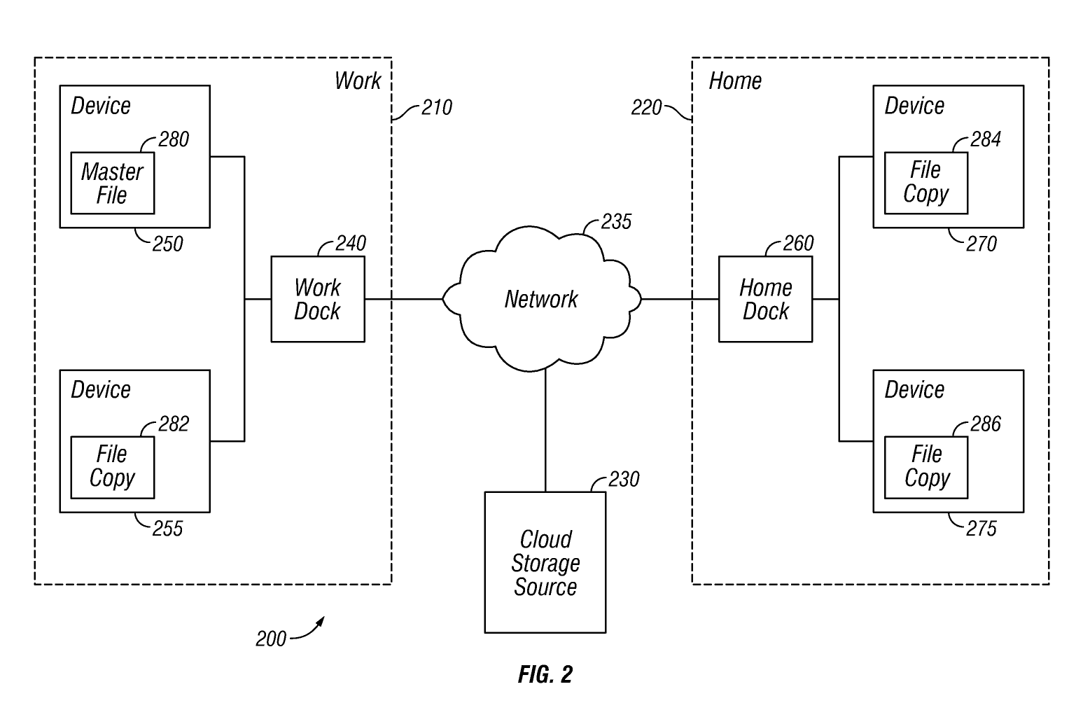

In particular embodiments, information handling system 100 may be a wireless-enabled, portable device that may include one or more processors 102 (e.g., dual core ARM processors), volatile memory 104 (e.g., RAM), non-volatile memory 104 (e.g., flash memory), input/output interfaces 108 (e.g., for display, for data, and for audio), networking/communications interfaces 110, and one or more operating systems (e.g., stored in memory 104 and operated on by processors 102). The input/output interfaces 108 may include display interfaces that support one or more of the Mobile High-Definition Link (MHL) standard, the High Definition Multimedia Interface (HDMI) standard, or the Display Port (DP) standard. The input/output interfaces 108 may also include one or more USB ports (e.g., standard, mini or micro USB), one or more removable memory slots (e.g., SD card slots), and audio capabilities through the MHL, HDMI, or DP interfaces. Information handling system 100 may include networking or communication interfaces 110 that support IEEE 802.11 WLAN protocols (including a, b, g, n, or ac, or further variants such as 801.11h and 802.11f), single or dual band WiFi, BLUETOOTH communication, and near field communication (NFC). Information handling system 100 may include one or more operating systems, including versions of Android, Windows, Wyse ThinOS, Linux, or Apple iOS. Information handling system 100 may include one or more native applications, including, for example, a browser, a media player and recorder, voice over IP and video communication software, and software for remote access to cloud services or other remote content or services. Information handling system 100 may connect through a network to cloud storage systems, as described in more detail with respect to FIG. 2. A user may, for example, use information handling system 100 to securely communicate and/or access files or contents that are on a cloud storage system.

FIG. 2 illustrates an example network environment 200 in which an information handling system may operate with other local or remote devices, in accordance with some embodiments of the present disclosure. In the example of FIG. 2, work network 210, home network 220, and cloud storage service 230 are communicatively coupled through a suitable network 235. Network 235 may include, for example, an ad hoc network, a personal area network (PAN), a local area network (LAN), a wide area network (WAN), a metropolitan area network (MAN), or one or more portions of the Internet or a combination of two or more of these network types. One or more portions of network 235 may be wired or wireless. As an example, network 235 may include portions of a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some embodiments, work network 210 includes docking station 240, device 250, and device 255. Docking station 240 may be referred to as “work dock 240.” Work dock 240 may be any suitable type of router or docking station. Devices 250 and 255 are information handling systems communicatively coupled in any suitable wired or wireless fashion to work dock 240. As an example and not by way of limitation, device 250 may be a desktop computer, and device 255 may be a laptop computer. However, devices 250 and 255 may be tablets, smartphones, external storage systems, or any other suitable information handling systems. Although this disclosure describes and illustrates particular devices 250 and 255, this disclosure contemplates any suitable information handling system or device. Furthermore, although this disclosure describes and illustrates two devices 250 and 255, any suitable number of devices may be used.

Work dock 240 may include the ability to create a network between work dock 240 and devices 250 and 255. The network may include, for example, an ad hoc network, a personal area network (PAN), a local area network (LAN), a wide area network (WAN), a metropolitan area network (MAN), or one or more portions of the Internet or a combination of two or more of these network types. One or more portions of the network may be wired or wireless. As an example, the network may include portions of a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

As shown in FIG. 2, work dock 240 may allow devices 250 and 255 to couple to it and communicate with home network 220 or cloud storage system 230. Work dock 240 may also allow devices coupled to it to communicate with each other. Although not illustrated in FIG. 2, one or more of the devices of network environment 200 may, in particular embodiments, communicate with each other directly (e.g., wirelessly) or via any other suitable communication method. Additionally communications between devices 250 and 255, home network 220, and cloud storage system 230 may be encrypted. The data transferred between devices 250 and 255, home network 220, and cloud storage system 230 may, for example, be encrypted using standard encryption, proprietary encryption, or a combination of both types.

Work dock 240 may allow devices 250 and 255 to automatically dock with work dock 240. Prior to an automatic dock with a device, work dock 240 may authenticate the device. Work dock 240 may also allow devices 250 and 255 to manually dock with work dock 240. Work dock 240 may authenticate devices by prompting for a user name and password, via Wired Equivalent Privacy (WEP) security, via Wi-Fi Protected Access (WPA) security, via a smart card, USB token, software token, secure credentials, biometric authentication, two-phase authentication, or any other suitable authentication method.

In some embodiments, home network 220 includes docking station 260, device 270, and device 275. Docking station 260 may be referred to as “home dock 260.” Home dock 260 may be any suitable type of router or docking station. Devices 270 and 275 are information handling systems communicatively coupled in any suitable wired or wireless fashion to work dock 260. As an example and not by way of limitation, device 270 may be a desktop computer, and device 275 may be a laptop computer. However, devices 270 and 275 may be tablets, smartphones, external storage systems, or any other suitable information handling systems. Although this disclosure describes and illustrates particular devices 270 and 275, this disclosure contemplates any suitable information handling system or device. Furthermore, although this disclosure describes and illustrates two devices 270 and 275, any suitable number of devices may be used.

Home dock 260 may include the ability to create a network between home dock 260 and devices 270 and 275. The network may include, for example, an ad hoc network, a personal area network (PAN), a local area network (LAN), a wide area network (WAN), a metropolitan area network (MAN), or one or more portions of the Internet or a combination of two or more of these network types. One or more portions of the network may be wired or wireless. As an example, the network may include portions of a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

Home dock 260 may allow devices 270 and 275 to automatically dock with home dock 260. Prior to an automatic dock with a device, home dock 260 may authenticate the device. Home dock 260 may also allow devices 270 and 275 to manually dock with home dock 260. Home dock 260 may authenticate devices by prompting for a user name and password, via Wired Equivalent Privacy (WEP) security, via Wi-Fi Protected Access (WPA) security, via a smart card, USB token, software token, secure credentials, or any other suitable authentication method.

As shown in FIG. 2, home dock 260 may allow devices 270 and 275 to couple to it and communicate with work network 210 or cloud storage system 230. Home dock 260 may also allow devices coupled to it to communicate with each other. Although not illustrated in FIG. 2, one or more of the devices of network environment 200 may, in particular embodiments, communicate with each other directly (e.g., wirelessly) or via any other suitable communication method. Additionally communications between devices 270 and 275, work network 210, and cloud storage system 230 may be encrypted. The data transferred between devices 270 and 275, work network 210, and cloud storage system 230 may, for example, be encrypted using standard encryption, proprietary encryption, or a combination of both types.

Work dock 240 and home dock 260 may also communicate with each other directly via any suitable communication method. Additionally, communications between work dock 240 and home dock 260 may be encrypted. The data transferred between work dock 240 and home dock 260 may, for example, be encrypted using standard encryption, proprietary encryption, or a combination of both types. In some embodiments, work dock 240 and home dock 260 may use an encrypted channel between the docking stations to transmit communications between devices 250-255 and devices 270-275.

Cloud storage system 230 may be any system suitable for storing and accessing data over a network. In some embodiments, cloud storage system 230 may include a cloud storage service such as Google Drive, DropBox, SkyDrive, SugarSync, Box.com, or any other suitable cloud storage service. In some embodiments, cloud storage system 230 includes one or more servers and one or more data storage systems. Cloud storage system 230 may contain files from multiple devices in a single data structure. Cloud storage system 230 may index the files to allow devices to navigate to the files. Cloud storage system may be used to store data at the direction of a user or may be used to store data at the direction of docking stations 240 and 260. Cloud storage system 230 may provide, for example, access to data, applications, services, or remote desktops. In some embodiments, cloud storage system 230 may be located remote from docking stations 240 and 260. In other embodiments, cloud storage system 230 may be located locally to docking station 240 or 260. In some embodiments, cloud storage system 230 may be accessed by a device 250 or 255 when the device 250 or 255 is connected to dock 240. In other embodiments, cloud storage system 230 may be accessed by a device 250 or 255 when the device 250 or 255 is not connected to dock 240. In some embodiments, cloud storage system 230 may be accessed by a device 270 or 275 when the device 270 or 275 is connected to dock 260. In other embodiments, cloud storage system 230 may be accessed by a device 270 or 275 when the device 270 or 275 is not connected to dock 260. Although this disclosure describes and illustrates a particular cloud storage system 230, this disclosure contemplates any suitable cloud storage system and any suitable number of cloud storage systems.

As an example and not by way of limitation, in FIG. 2, device 250 may contain master file 280. In some embodiments, work dock 240 detects that device 250 contains a new master file 280 when device 250 docks with work dock 240. The detection may also include detecting that device 250 contains a previously detected master file 280 that has been revised or updated since the file was last detected by work dock 240. The types of files detected by work dock 240 may be any type of file included on an information handling system including, but not limited to, documents, presentations, databases, email files, audio files, video files, and picture files. In some embodiments, the user of device 250 may specify which types of files work dock 240 should automatically detect. In other embodiments, the user of device 250 may specify one or more locations on device 250 where work dock 240 may look to detect new files. In yet another embodiment, the user of work dock 240 may identify one or more specific files to be detected by work dock 240.

In some embodiments, the user of device 250 may desire to access master file 280 using a different device. For example, the user may desire to access master file 280 using device 255. In that case, device 255 may request a copy of master file 280 from work dock 240. Work dock 240 may obtain master file 280 from device 250 and return a copy to device 255 or store it on device 255 as file copy 282. In some embodiments, work dock 240 may obtain master file 280 and store file copy 282 without user intervention. In some embodiments, work dock 240 may cache a copy of master file 280 for later comparison, as described below. In such embodiments, work dock 240 may periodically discard or refresh its cached copy of master file 280. As another example, the user may desire to access master file 280 using device 270. In that case, home dock 260 may contact work dock 240 to request a copy of master file 280. In some embodiments, work dock 240 may obtain master file master file 280 from device 250 and deliver a copy to home dock 260. In some embodiments, work dock 240 may deliver a cached copy of master file 280 to home dock 260. Work dock 240 may additionally store information indicating that a copy of master file 280 was sent to home dock 260. Home dock may return the copy to device 270 or store it on device 270 as file copy 284. In some embodiments, home dock 240 may request master file 280 and store file copy 284 without user intervention. In some embodiments, home dock 260 may cache a copy of master file 280 for later comparison, as described below. In such embodiments, work dock 240 may deliver to home dock 260 a set of differences between master file 280 and home dock 260′s cached copy of master file 280.

In some embodiments, the user may alter file copy 282. For example, in embodiments where master file 280 and file copy 282 are word processing document, the user may edit file copy 282 using a word processor. Work dock 240 may detect that file copy 282 has been altered. In some embodiments, work dock 240 may obtain file copy 282 and compare it to master file 280. In other embodiments, work dock may obtain file copy 282 and compare it to its cached copy of master file 280. For example, work dock 240 may compare the modification time of file copy 282 to the modification time of master file 280 or a cached copy of master file 280. When file copy 282 is newer, work dock 240 may identify the differences between file copy 282 and master file 280. Work dock 240 may additionally update master file 280, using the differences, to match file copy 282. In some embodiments, work dock 240 may obtain file copy 282 and store master file 280 without user intervention. In some embodiments, work dock 240 compares file copy 282 and master file 280 when requested by the user. In some embodiments, work dock 240 compares file copy 282 and master 280 on a predetermined schedule or when a predetermined event occurs. For example, work dock 240 may compare file copy 282 and master file 280 when the user logs out of device 255. As another example, work dock 240 may compare file copy 282 and master file 280 whenever device 255 connects to work network 210. In some embodiments, work dock 240 compares file copy 282 and master 280 after a predetermined time has elapsed.

As another example, home dock 260 may detect that file copy 284 has been altered. For example, in embodiments where master file 280 and file copy 284 are picture files, the user may crop the picture using an image-editing application. In some embodiments, home dock 260 may obtain file copy 284 and compare it to master file 280. In other embodiments, work dock may obtain file copy 284 and compare it to its cached copy of master file 280. Home dock 260 may identify the differences between file copy 284 and master file 280. Home dock 260 may additionally send the identified differences to work dock 240. Work dock 240 may update master file 280, using those differences, to match file copy 284. In some embodiments, work dock 240 may update master file 280 without user intervention. In some embodiments, home dock 260 compares file copy 284 and master file 280 when requested by the user. In some embodiments, home dock 260 compares file copy 284 and master 280 on a predetermined schedule or when a predetermined event occurs. For example, home dock 260 may compare file copy 284 and master file 280 when the user logs out of device 270. As another example, home dock 260 may compare file copy 284 and master file 280 at 3:00 am, when the user is typically asleep and done working for the day. In some embodiments, work dock compares file copy 284 and master 280 after a predetermined time has elapsed.

In some embodiments, the user may alter master file 280. For example, in embodiments where master file 280 is a spreadsheet document, the user may edit master file 280 using a spreadsheet application. Work dock 240 may detect that master file 280 has been altered. In some embodiments, work dock 240 may obtain master file 280 and compare it to file copy 282. In other embodiments, work dock may obtain file copy 282 and compare it to its cached copy of master file 280. For example, work dock 240 may compare the modification time of file copy 282 to the modification time of master file 280 or a cached copy of master file 280. When master file 280 is newer, work dock 240 may identify the differences between file copy 282 and master file 280. Work dock 240 may additionally update file copy 282, using the differences, to match master file 280. In some embodiments, work dock 240 may additionally send master file 280 to home dock 260. In some embodiments, home dock 260 may already have a cached copy of master file 280. In such embodiments, work dock 240 may send only portions of master file 280 to home dock 260. For example, work dock 240 may send only the portions of master file 280 that have changed since home dock 260 last received a copy of master file 280. Home dock 260 may obtain file copy 284 from device 270 and compare it to master file 280. Home dock may identify the differences between file copy 284 and master file 280. Home dock 240 may additionally update file copy 284, using the differences, to match master file 280. In some embodiments, home dock 260 may update file copy 284 without user intervention. In some embodiments, work dock 240 compares file copy 284 and master file 280 when requested by the user. In some embodiments, work dock 240 compares file copy 284 and master 280 on a predetermined schedule or when a predetermined event occurs. For example, work dock 240 may compare file copy 284 and master 280 at 5:30 pm, when the user is typically commuting to his home. In some embodiments, work dock 240 compares file copy 284 and master 280 after a predetermined time has elapsed.

Although this disclosure describes and illustrates master file 280 as stored on device 250, this disclosure contemplates storing master file 280 on device 255, 270, or 275, on cloud storage system 230, or in any other suitable location accessible to docking station 240 or 260. Furthermore, although this disclosure describes and illustrates file copy 282 on device 255 and file copy 284 on device 270, file copies may be stored in any other suitable device. For example, file copy 286 may be stored on device 275.

Each of devices 250-255 and 270-275 may belong to a single user or to multiple users. Each of devices 250-255 and 270-275 may include a software application configured to allow for interaction with docking stations 240 and 260 and/or cloud storage service 230. Devices 250-255 and 270-275 may be the same platform or different platforms including, but not limited to, Apple iOS, Microsoft Windows, Android, Wyse ThinOS, or Linux.

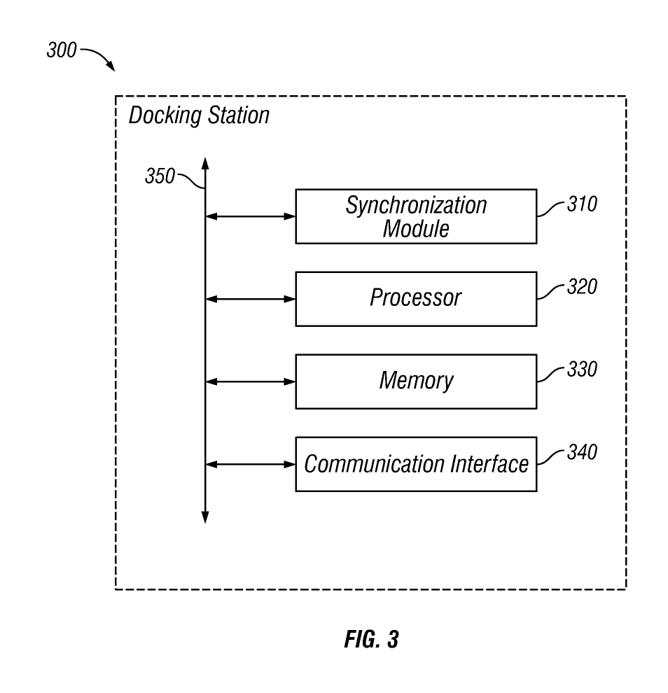

FIG. 3 illustrates a block diagram of selected elements of an embodiment of a docking station 300, in accordance with some embodiments of the present disclosure. In particular embodiments, one or more docking stations 300 may perform one or more steps of one or more methods described or illustrated herein. In particular embodiments, one or more docking stations 300 provide the functionality described or illustrated herein. In particular embodiments, software running on one or more docking stations 300 performs one or more steps of one or more methods described or illustrated herein or provides functionality described or illustrated herein. Particular embodiments include one or more portions of one or more docking stations 300. Moreover, reference to a docking station may encompass one or more docking stations, where appropriate. In some embodiments, network environment 200, discussed with reference to FIG. 2, may use docking station 300 as work dock 240, home dock 260, or both.

Where appropriate, one or more docking stations 300 may perform without substantial spatial or temporal limitation one or more steps of one or more methods described or illustrated herein. As an example and not by way of limitation, one or more docking stations 300 may perform in real time or in batch mode one or more steps of one or more methods described or illustrated herein. One or more docking stations 300 may perform at different times or at different locations one or more steps of one or more methods described or illustrated herein, where appropriate.

In some embodiments, docking station 300 includes synchronization module 310, processor 320, memory 330, input/output (I/O) interface 340, and bus 350. Although this disclosure describes and illustrates a particular docking station having a particular number of particular components in a particular arrangement, this disclosure contemplates any suitable docking station having any suitable number of any suitable components in any suitable arrangement.

In particular embodiments, synchronization module 310 includes hardware for executing instructions, such as those making up a computer program. As an example and not by way of limitation, to execute instructions, synchronization module 310 may retrieve (or fetch) the instructions from memory 330, decode and execute them, and then write one or more results to an internal register, an internal cache, or memory 330. Synchronization module 310 may also execute instructions on processor 320. Synchronization module 310 may execute instructions that may cause docking station 300 to obtain a master file or a file copy from a device or from a cloud storage service. Synchronization module 310 may also execute instructions that may cause docking station 300 to identify differences between a master file and a file copy. Synchronization module 310 may additionally execute instructions that may cause docking station 300 to transmit identified differences between a master file and a file copy to another docking station. Furthermore, synchronization module 310 may execute instructions that may cause docking station 300 to update a master file or a file copy using identified differences. Synchronization module 310 may be similar to processor 102 as described with reference to FIG. 1. This disclosure contemplates synchronization module 310 taking any suitable physical form. Where appropriate, synchronization module 310 may include one or more synchronization modules 310. Although this disclosure describes and illustrates a particular synchronization module, this disclosure contemplates any suitable module.

In particular embodiments, processor 320 includes hardware for executing instructions, such as those making up a computer program. As an example and not by way of limitation, to execute instructions, processor 320 may retrieve (or fetch) the instructions from an internal register, an internal cache, or memory 330; decode and execute them; and then write one or more results to an internal register, an internal cache, or memory 330. Processor 320 may be a similar processor to processor 102 as described with reference to FIG. 1. Although this disclosure describes and illustrates a particular processor, this disclosure contemplates any suitable processor.

In particular embodiments, memory 330 includes main memory for storing instructions for cloud storage management module 310 or processor 320 to execute or data for cloud storage management module 310 or processor 340 to operate on. Memory 330 may be similar to memory 104 as described with reference to FIG. 1. Memory 330 may include one or more memories 330, where appropriate. Although this disclosure describes and illustrates particular memory 330, this disclosure contemplates any suitable memory.

In particular embodiments, communication interface 340 includes hardware, software, or both providing one or more interfaces for communication (such as, for example, packet-based communication) between docking station 300 and one or more other docking stations 300, one or more devices, or one or more cloud storage systems. Communication interface 340 may be similar to communication interface 110 as described with reference to FIG. 1. Communication interface 340 may include one or more communication interfaces 340, where appropriate. Although this disclosure describes and illustrates a particular communication interface, this disclosure contemplates any suitable communication interface.

In particular embodiments, bus 350 includes hardware, software, or both coupling components of docking station 300 to each other. Bus 350 may be any suitable bus, such as any bus 112 as described with reference to FIG. 1. Bus 350 may include one or more buses 350, where appropriate. Although this disclosure describes and illustrates a particular bus, this disclosure contemplates any suitable bus or interconnect.

In particular embodiments, docking station 300 may include one or more native applications, including, for example, software for providing access to cloud services, software for managing users and device access to docking station 300, or software for managing features of a router. Docking station 300 may connect through to a cloud services system and may connect to other devices, as described in FIG. 2.

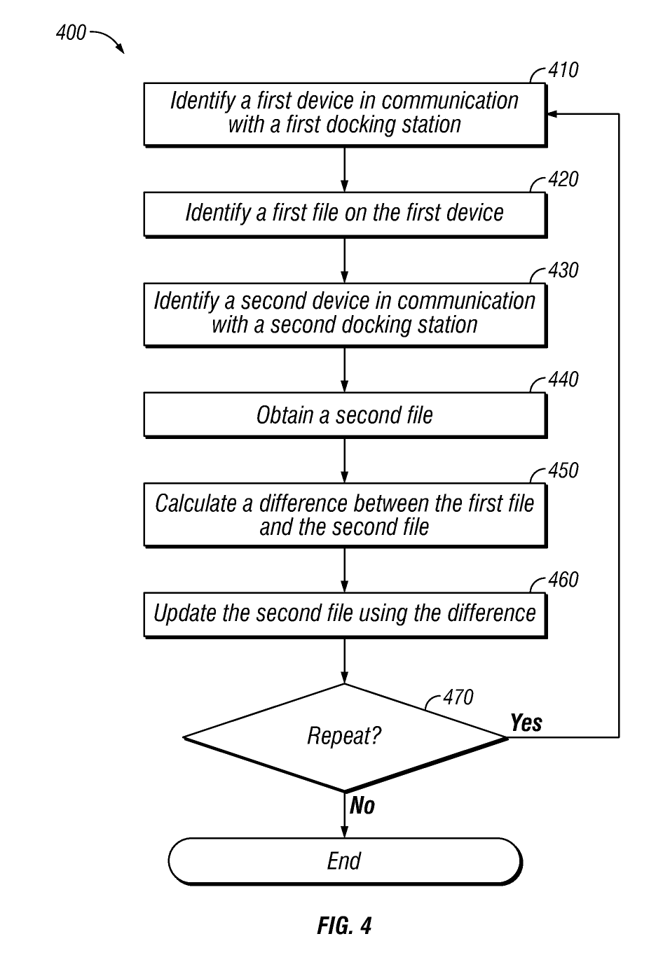

FIG. 4 illustrates an example method 400 for synchronizing data between two geographically disparate locations, in accordance with some embodiments of the present disclosure. The method may begin at step 410, where a first device in communication with a first docking station may be identified. For example, the first docking station may be work dock 240 and the first device may be device 250, discussed with reference to FIG. 2. As another example, the first docking station may be home dock 260 and the first device may be device 270, discussed with reference to FIG. 2. The first device may automatically connect with the first docking station. The automatic connection may include an authentication step. The automatic connection may also require that the first device be previously set-up to communicate and connect with the first docking station. The first device may automatically connect with the first docking station without any action by the user. For example, the first device may automatically connect with the first docking without the user having to authenticate the connection. The first device may not be physically connected to the first docking station. For example, the first device may connect with the first docking station via Wi-Fi or any other suitable wireless method for connecting devices.

In step 420, a first file on the first device may be identified. In some embodiments, a user may identify the first file. In other embodiments, the first file may be identified automatically. For example, the first file may be identified when an alteration to the first file is detected. In some embodiments, the first file is a master file. For example, the first file may be master file 280, discussed with reference to FIG. 2. In some embodiments, the first file is a file copy. For example, the first file may be file copy 282 or file copy 284, discussed with reference to FIG. 2.

In step 430, a second device in communication with a second docking station may be identified. For example, in embodiments where the first docking station is work station 240, the second docking station may be home docking station 260 and the second device may be device 270, discussed with reference to FIG. 2. As another example, in embodiments where the first docking station is home station 260, the second docking station may be work docking station 240 and the second device may be device 250. The second device may automatically connect with the second docking station. The automatic connection may include an authentication step. The automatic connection may also require that the second device be previously set-up to communicate and connect with the second docking station. The second device may automatically connect with the second docking station without any action by the user. For example, the second device may automatically connect with the second docking without the user having to authenticate the connection. The second device may not be physically connected to the second docking station. For example, the second device may connect with the second docking station via Wi-Fi or any other suitable wireless method for connecting devices. Furthermore, in some embodiments, the first and second docking stations are in communication.

In step 440, a second file may be obtained. In some embodiments, the second file is a master file. In some embodiments, the second file is obtained from the second device identified in step 430. For example, in embodiments where the first file is file copy 284, the second file may be master file 280, discussed with reference to FIG. 2. In some embodiments, the second file is a file copy. For example, in embodiments where the first file is master file 280, the second file may be file copy 282 or file copy 284, discussed with reference to FIG. 2. In some embodiments, the second file is obtained from a cloud storage system. For example, the second file may be obtained from cloud storage system 230, discussed with reference to FIG. 2.

In step 450, a difference between the first and second file is calculated. In some embodiments, the first file is transmitted to the second docking station, where the first and second files are compared. In some embodiments, the second file is transmitted to the first docking station, where the first and second files are compared. In some embodiments, the second docking station obtains a copy of the second file for comparison. In other embodiments, a cached copy of the second file is used for comparison.

In step 460, the second file is updated using the difference. In some embodiments, the second file and the first file are identical after the update. In some embodiments, the second file is updated without user intervention.

In step 470, it may be determined whether to repeat method 400. If so, method 400 may return to step 410. Otherwise, method 400 may terminate.

Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for synchronizing data between two geographically disparate locations including the particular steps of the method of FIG. 4, this disclosure contemplates any suitable method for synchronizing data between two geographically disparate locations including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4. For example, some steps of FIG. 4 may be performed by work dock 240 while other steps of FIG. 4 are performed by home dock 260.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method for synchronizing data between two geographically disparate locations, comprising:
identifying a first file on a first device in communication with a first docking station;
obtaining a second file at a second docking station in communication with the first docking station;
calculating a difference between the first file and the second file; and
updating the first file using the difference.

2. The method of claim 1, wherein the second file is obtained from a cloud storage service.

3. The method of claim 1, wherein the second file is obtained from a second device in communication with the second docking station.

4. The method of claim 1, wherein calculating the difference between the first file and the second file comprises:
transmitting the first file from the first docking station to the second docking station; and
comparing, at the second docking station, the first file and the second file.

5. The method of claim 4, further comprising caching a copy of the second file at the second docking station, wherein comparing the first file and the second file comprises comparing the first file and the cached copy of the second file.

6. The method of claim 1, wherein calculating the difference between the first file and the second file comprises:
transmitting the second file from the second docking station to the first docking station; and
comparing, at the first docking station, the first file and the second file.

7. The method of claim 6, further comprising caching a copy of the second file at the first docking station, wherein comparing the first file and the second file comprises comparing the first file and the cached copy of the second file.

8. A non-transitory computer readable medium, comprising computer readable instructions which, when executed, cause a processor to:
identify a first file on a first device in communication with a first docking station;
obtain a second file at a second docking station in communication with the first docking station;
calculate a difference between the first file and the second file; and
update the first file using the difference.

9. The non-transitory computer readable medium of claim 8, wherein the second file is obtained from a cloud storage service.

10. The non-transitory computer readable medium of claim 8, wherein the second file is obtained from a second device in communication with the second docking station.

11. The non-transitory computer readable medium of claim 8, wherein calculating the difference between the first file and the second file comprises:
transmitting the first file from the first docking station to the second docking station; and
comparing, at the second docking station, the first file and the second file.

12. The non-transitory computer readable medium of claim 11, the computer readable instructions further causing the processor to cache a copy of the second file at the second docking station, wherein comparing the first file and the second file comprises comparing the cached copy of the first file and the second file.

13. The non-transitory computer readable medium of claim 8, wherein calculating the difference between the first file and the second file comprises:
transmitting the second file from the second docking station to the first docking station; and
comparing, at the first docking station, the first file and the second file.

14. The non-transitory computer readable medium of claim 13, the computer readable instructions further causing the processor to cache a copy of the second file at the first docking station, wherein comparing the first file and the second file comprises comparing the cached copy of the first file and the second file.

15. An information handling system, comprising:
at least one processor;
a memory communicatively coupled to the at least one processor;
a first docking station;
a second docking station; and
a synchronization module resident in the memory and including computer readable instructions which, when executed, cause the processor to:
identify a first file on a first device in communication with the first docking station;
obtain a second file at a second docking station in communication with the first docking station;
calculate a difference between the first file and the second file; and
update the second file using the difference.

16. The information handling system of claim 15, wherein the second file is obtained from a second device in communication with the second docking station.

17. The information handling system of claim 15, wherein calculating the difference between the first file and the second file comprises:
transmitting the first file from the first docking station to the second docking station; and
comparing, at the second docking station, the first file and the second file.

18. The information handling system of claim 17, the computer readable instructions further causing the processor to cache a copy of the first file at the second docking station, wherein comparing the first file and the second file comprises comparing the cached copy of the first file and the second file.

19. The information handling system of claim 15, wherein calculating the difference between the first file and the second file comprises:
transmitting the second file from the second docking station to the first docking station; and
comparing, at the first docking station, the first file and the second file.

20. The information handling system of claim 19, the computer readable instructions further causing the processor to cache a copy of the first file at the first docking station, wherein comparing the first file and the second file comprises comparing the cached copy of the first file and the second file.
